(19) United States
(12) Patent Application Publication
(10) Pub. No.: US 2005/0008838 A1
(43) Pub. Date: Jan. 13, 2005

(54) Rare-earth permanent magnet having corrosion-resistant coating, process for producing the same, and treating liquid for forming corrosion-resistant coating

(76) Inventors: Kazuhide Ohshima, Osaka (JP); Seiichi Sakaguchi, Osaka (JP); Tetuyuki Nakagishi, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/493,059

(22) PCT Filed: Nov. 11, 2002
(86) PCT No.: PCT/JP02/11726

(30) Foreign Application Priority Data
Nov. 9, 2001 (JP) 2001-344527

(51) Int. Cl. H01F 1/04; B32B 27/30; B05D 3/02

(52) U.S. Cl. 428/219; 428/522; 148/301; 427/388.4

(57) ABSTRACT

The invention aims to provide a rare earth metal-based permanent magnet which has on the surface an inexpensive corrosion-resistant film combining excellent heat-resistance with excellent adhesiveness; a process for producing the permanent magnet; and a treating liquid for forming the corrosion-resistant film. The invention provides a rare earth metal-based permanent magnet characterized by it has on the surface a corrosion-resistant film containing lithium silicate and a thermoplastic resin as the constituting components, the film containing uniformly dispersed therein the thermoplastic resin at a content of 0.1 wt % to 50 wt %. The treating liquid, which is an excellent liquid for forming the corrosion-resistant film, is characterized by that a soap-free aqueous emulsion of a thermoplastic resin was used and that it contains the thermoplastic resin and lithium silicate in given amounts. The process, which is for producing the rare earth metal-based permanent magnet, is characterized by forming a corrosion-resistant film by using the treating liquid.

### TECHNICAL FIELD

The invention relates to a rare earth metal-based permanent magnet which has on the surface an inexpensive corrosion-resistant film combining excellent heat-resistance with excellent adhesiveness; a process for producing the permanent magnet; and a treating liquid for forming the corrosion-resistant film.

### BACKGROUND ART

Rare earth metal-based permanent magnets, for instance, R—Fe—B based permanent magnets represented by a Nd—Fe—B based permanent magnet, or R—Fe—N based permanent magnets represented by a Sm—Fe—N based permanent magnet, etc., utilize inexpensive materials abundant in resources and possess superior magnetic properties, and particularly among them, R—Fe—B based permanent magnets are employed today in various fields.

However, since a rare earth metal-based permanent magnet contains a highly reactive rare earth metal, i.e., R, they are apt to be oxidized and corroded in ambient, and in case they are used without applying any surface treatment, corrosion tends to proceed from the surface in the presence of small acidic or alkaline substance or water to generate rust, and this brings about the degradation and the fluctuation in magnetic properties. Moreover, in case such a rusty magnet is embedded in a magnetic circuit and a like device, there is fear of scattering rust as to contaminate peripheral components.

Accordingly, it has been well known for long to form various types of corrosion-resistant film on the surface of a rare earth metal-based permanent magnet.

On the other hand, with recent increase in the application area of rare earth metal-based permanent magnets, the corrosion-resistant films that are formed on the surface thereof are required to possess excellent performance for not only high corrosion-resistance, but also heat-resistance when used under severe temperature changing environmental conditions as well as adhesiveness with organic resins represented by adhesives used in embedding the components. Furthermore, it is desired that the formed corrosion-resistant film is inexpensive.

Accordingly, the objectives of the invention is to provide a rare earth metal-based permanent magnet which has on the surface an inexpensive corrosion-resistant film combining excellent heat-resistance with excellent adhesiveness; a process for producing the permanent magnet; and a treating liquid for forming the corrosion-resistant film.

### DISCLOSURE OF THE INVENTION

In the light of such circumstances, the inventors have conducted extensive studies, and in due course, they have paid attention to the process of forming a glassy protective film containing alkali silicate as the constituting component of the corrosion-resistant film that is formed on the surface of the rare earth metal-based permanent magnet. The corrosion-resistant film containing alkali silicate as the constituting component is one of the corrosion-resistant films known for long, and it satisfies the requirement above in the point that it can be formed at low cost; however, in due course of the inventors' study, it has been found that the performances of the film, inclusive of the corrosion-resistance, are not yet sufficient, and that it was necessary to further improve the performances. Furthermore, various studies are made recently on the glassy protective film with the aim of improving the performances; for instance, in U.S. Pat. No. 6,174,609 is proposed a corrosion-resistant film containing from 3 wt % to 10 wt % of alkali silicate and from 90 wt % to 97 wt % of a thermosetting resin as the constituting components, and such a constitution enables a corrosion-resistant film with higher corrosion-resistance. However, the heat-resistance and adhesiveness of the corrosion-resistant film were found still insufficient.

Accordingly, further studies were conducted, and it has been found that, by uniformly dispersing a predetermined amount of thermoplastic resin in a film containing lithium silicate as the constituting component, lithium silicate and the thermoplastic resin congruently form a uniform three-dimensional network structure, that a corrosion-resistant film having excellent heat-resistance can be obtained, which, even during use under severe temperature changing environmental conditions, effectively prevents the cracks that generate in the film itself ascribed to the thermal shrinking of the film, or the cracks that generate between the film and the base magnet attributed to the difference in thermal expansion ratio, and that a corrosion-resistant film, which exhibits not only excellent adhesiveness with various types of adhesives but also less tendency to cause degradation in adhesiveness, can be obtained.

The invention has been accomplished through the research process above, and a rare earth metal-based permanent magnet of the invention is, as disclosed in the first claim, characterized by that it has on the surface a corrosion-resistant film containing lithium silicate and a thermoplastic resin as the constituting components, the film containing uniformly dispersed therein the thermoplastic resin at a content of 0.1 wt % to 50 wt %.

The rare earth metal-based permanent magnet disclosed in the second claim of the invention is the rare earth metal-based permanent magnet as claimed in claim 1, characterized by that the film further contains sodium silicate as the constituting component.

The rare earth metal-based permanent magnet disclosed in the third claim of the invention is the rare earth metal-based permanent magnet as claimed in claim 2, characterized by that the film has sodium content of 10 wt % or less.

The rare earth metal-based permanent magnet disclosed in the fourth claim of the invention is the rare earth metal-based permanent magnet as claimed in claim 1, characterized by that the thermoplastic resin is a soap-free aqueous emulsion of resin.

The rare earth metal-based permanent magnet disclosed in the fifth claim of the invention is the rare earth metal-based permanent magnet as claimed in claim 1, characterized by that the thermoplastic resin is acrylic-styrene resin.

The rare earth metal-based permanent magnet disclosed in the sixth claim of the invention is the rare earth metal-based permanent magnet as claimed in claim 1, characterized by that the magnet has the film at a coverage of 0.01 g/m² to 5.0 g/m² per unit surface area of the magnet.

A process for producing a rare earth metal-based permanent magnet of the invention is, as disclosed in the seventh claim, characterized by that it comprises preparing a treating liquid containing from 0.1 wt % to 5 wt % of a thermoplastic resin and from 2 wt % to 30 wt % of lithium silicate by dispersing the thermoplastic resin in the form of a soap-free aqueous emulsion of resin in an aqueous solution of lithium silicate, and after applying the treating liquid to the surface of the magnet, heating and drying it to obtain the corrosion-resistant film.

The production process disclosed in the eighth claim of the invention is the production process as claimed in claim 7, characterized by that the treating liquid further contains sodium silicate.

The production process disclosed in the ninth claim of the invention is the production process as claimed in claim 8, characterized by that the sodium content of the treating liquid is 1 wt % or less.

The production process disclosed in the tenth claim of the invention is the production process as claimed in claim 7, characterized by that the thermoplastic resin is acrylic-styrene resin.

A treating liquid for forming a corrosion-resistant film on the surface of a rare earth metal-based permanent magnet of the invention is, as disclosed in the eleventh claim, characterized by that it contains from 0.1 wt % to 5 wt % of a thermoplastic resin in the form of a soap-free aqueous emulsion of resin and from 2 wt % to 30 wt % of lithium silicate.

The treating liquid disclosed in the twelfth claim of the invention is the treating liquid as claimed in claim 11, characterized by that the treating liquid further contains sodium silicate.

The treating liquid disclosed in the thirteenth claim of the invention is the treating liquid as claimed in claim 12, characterized by that the sodium content of the treating liquid is 1 wt % or less.

The treating liquid disclosed in the fourteenth claim of the invention is the treating liquid of as claimed in claim 11, characterized by that the thermoplastic resin is acrylic-styrene resin.

### BEST MODE FOR CARRYING OUT THE INVENTION

The rare earth metal-based permanent magnet of the invention is characterized by that it has on the surface a corrosion-resistant film containing lithium silicate and a thermoplastic resin as the constituting components, the film containing uniformly dispersed therein the thermoplastic resin at a content of 0.1 wt % to 50 wt %.

The corrosion-resistant film of the invention contains lithium silicate as one of the constituting components. The corrosion-resistant film containing lithium silicate as the constituting component is formed from an aqueous solution of lithium silicate expressed by general formula of Li₂O.nSiO₂, which, by nature, is characterized by having excellent corrosion-resistance. In the general formula, n represents molar ratio (SiO₂/Li₂O), and in the invention, generally employed are those having n in the range of 1.5 to 10.

The corrosion-resistant film of the invention may contain lithium silicate alone as the alkali silicate component, but it may further contain sodium silicate (water glass), potassium silicate, or ammonium silicate as the constituting component in addition to lithium silicate. Among them, it is possible to assure favorable filming properties during forming the film and tight adhesiveness with the magnet by using sodium silicate as the constituting component of the film. Furthermore, by using sodium silicate as the constituting component of the film, in case there should be any external flaws or cracks in the film, little sodium silicate dissolves into water, and it penetrates and solidifies in the flaws or cracks to exhibit self-repairing corrosion-resistant function. In case sodium silicate is used as the constituting component of the film, it is preferred that the content thereof in the film is controlled to 10 wt % or less, and more preferably, 5 wt % or less, based on sodium content. If the content should exceed 10 wt %, it may cause unfavorable influence on the water-resistance of the formed film, and this is feared to bring about the degradation in heat-resistance and adhesiveness.

As the thermoplastic resin usable as the constituting component of the corrosion-resistant film of the invention, there can be mentioned, for instance, acrylic resin, acrylic-styrene resin, polyester resin, polyamide resin, polycarbonate resin, and the like. The thermoplastic resin is uniformly dispersed in the film at a content of 0.1 wt % to 50 wt %. In case the content should be less than 0.1 wt %, the formed film cannot exhibit excellent adhesiveness or heat-resistance. On the other hand, if the content should exceed 50 wt %, the resin undergoes surface coagulation at high temperatures as to cause not only impaired heat-resistance, but also influences on adhesiveness in some types of adhesives. The content of the thermoplastic resin that is uniformly dispersed in the film is preferably in a range of 1 wt % to 30 wt %, and more preferably, 5 wt % to 20 wt %.

The corrosion-resistant film of the invention is formed by preparing a treating liquid by dispersing a thermoplastic resin in an aqueous solution of lithium silicate, and after applying spray coating of the treating liquid to the surface of the magnet or immersion coating by immersing the magnet in the treating liquid, by heating and drying it under a temperature condition of 60° C. to 300° C. for 1 minute to 120 minutes, for instance. In order to form a corrosion-resistant film having excellent performance on the surface of the magnet, it is a key to uniformly disperse the thermoplastic resin in the treating liquid. Furthermore, by taking into consideration of mass production, it is ideal that the treating liquid thus prepared has excellent storage stability and a long pot life. In the light of such circumstances, it is preferred to use a soap-free aqueous emulsion of resin containing no added emulsifier (surface-activating agent) as the thermoplastic resin to be dispersed in the aqueous solution of lithium silicate. Since the aqueous solution of alkali silicate is alkaline (pH10 to pH13; liquid prepared in such pH range is free from problems of corroding the magnet and is also preferred from the environmental viewpoint on handling), in case the thermoplastic resin is dispersed in the form of an aqueous emulsion of resin containing added therein an emulsifier (particularly, nonionic surface-activating agent), there often causes emulsion destruction in the liquid and gelation of the resin leading to difficulties in preparing the treating liquid having the thermoplastic resin uniformly dispersed therein. Such a case may result in the failure of forming a corrosion-resistant film with excellent performance. Moreover, such a treating liquid is, as a matter of course, inferior concerning pot life because of the phenomenon described above.

According to the inventors' study, it appears that a treating liquid prepared by dispersing acrylic-styrene resin as the thermoplastic resin in the form of a soap-free aqueous emulsion of resin in an aqueous solution of lithium silicate excellently shows uniform dispersibility of acrylic-styrene resin in the treating liquid. Thus, the corrosion-resistant film formed by using the treating liquid contains acrylic-styrene resin uniformly dispersed in the film to exhibit excellent heat-resistance and adhesiveness. Acrylic-styrene resin signifies resin obtained by polymerizing a styrene monomer and an acrylic acid ester monomer. As the styrene monomer, usable are styrene, α-methylstyrene, and the like. As the acrylic acid ester monomer, testable are methyl acrylate, ethyl acrylate, propyl acrylate, butyl acrylate, 2-ethylhexyl acrylate, methyl methacrylate, ethyl methacrylate, propyl methacrylate, butyl methacrylate, 2-ethylhexyl methacrylate, and the like. Preferred acrylic-styrene resins include styrene—methyl methacrylate copolymer, styrene—butyl acrylate copolymer, styrene—methyl methacrylate—butyl acrylate copolymer, styrene—butyl methacrylate, and the like. As a soap-free aqueous emulsion type acrylic-styrene resin, favorably usable is, for instance F-2000 (trademark), a product of Asahi Kasei Corporation.

As a favorable treating liquid for forming a corrosion-resistant film having excellent performance, there can be mentioned a treating liquid containing from 0.1 wt % to 5 wt %, preferably from 0.5 wt % to 3 wt %, of a thermoplastic resin in the form of a soap-free aqueous emulsion of resin, together with from 2 wt % to 30 wt % of lithium silicate, and it is preferred that the treating liquid is properly prepared in this composition range in such a manner that the thermoplastic resin uniformly dispersed in the film is contained in the desired amount. In case sodium silicate is incorporated as an alkali silicate in the treating liquid, it is preferred that sodium content of the treating liquid is 1 wt % or less.

The corrosion-resistant film of the invention is preferably formed in such a manner that the magnet has the film at a coverage of 0.01 g/m² or higher (about 15 nm or more in film thickness) per unit surface area of the magnet. If the coverage of the film should be lower than 0.01 g/m², there is fear that the film insufficiently exhibits the performance as a corrosion-resistant film. Although the upper limit of the coverage of the film is not particularly limited, an excessively high amount of coverage makes it difficult to assure uniform adhesion on the entire surface of the magnet, and there is fear of causing unfavorable influence to the adhesiveness with organic resins represented by adhesives. Accordingly, the upper limit of the coverage of the film is preferably 5.0 g/m².

As the rare earth metal-based permanent magnets applicable to the invention, there can be mentioned known rare earth metal-based permanent magnets, for example, R—Fe—B based permanent magnets, R—Fe—N based permanent magnets, and the like. Among them, R—Fe—B based permanent magnets are preferred, as described above, from the viewpoint of possessing high magnetic properties, of having excellent mass productivity as well as economical advantage, and of exhibiting excellent adhesiveness with the film. The rare earth element (R) of these rare earth metal-based permanent magnets is preferably at least one selected from Nd, Pr, Dy, Ho, Tb, and Sm, or at least one selected from La, Ce, Gd, Er, Eu, Tm, Yb, Lu, and Y.

In general, one of the aforementioned rare earth metals is sufficient for use as R, but in practice, from the viewpoint of ease in availability and the like, it is possible to use a mixture of two or more (misch metal, didymium and the like).

Furthermore, by adding at least one selected from Al, Ti, V, Cr, Mn, Bi, Nb, Ta, Mo, W, Sb, Ge, Sn, Zr, Ni, Si, Zn, Hf, and Ga, it is possible to improve the coercive force, the rectangularity of a demagnetizing curve, and productivity, or to reduce cost. Furthermore, by substituting a part of Fe with Co, the temperature characteristics of the resulting magnet can be improved without impairing the magnetic properties.

The rare earth metal-based permanent magnet with which the invention applied may be a sintered magnet or a bonded magnet.

Further, an additional film may be formed as a laminate on the surface of the corrosion-resistant film of the invention. By employing such a constitution, the characteristics of the corrosion-resistant film can be enforced or complemented, or additional function can be provided to the film.

### EXAMPLE

The invention is described in further detail below by way of examples, but it should be understood that the invention is not only limited thereto.

### Example A

According to disclosures of, for example, U.S. Pat. No. 4,770,723 or U.S. Pat. No. 4,792,368, a known cast ingot was pulverized and then subjected sequentially to a pressing, a sintering, a heat treatment and a surface working, thereby producing a flat-plate sintered magnet having the size of 30 mm in length, 20 mm in width and 3 mm in height, with the composition of 14Nd-79Fe-6B-1Co (at %) (which is referred to hereinafter as bulk magnet test piece). A corrosion-resistant film was formed on the surface of the thus obtained bulk magnet test piece according to the following process.

1: Preparation of Treating Liquid and the Storage Stability Thereof

Various types of resins were added into various types of aqueous solutions of alkali silicates, and were each mixed and stirred using a stirrer to obtain 15 types of treating liquids as shown in Table 1. In Table 1, resin a is F-2000 (trademark), a soap-free aqueous emulsion type acrylic-styrene resin (a thermoplastic resin of Asahi Kasei Corporation.); resin b is M6520 (trademark), an emulsifier-added aqueous emulsion type acrylic-styrene resin (a thermoplastic resin of Clariant Polymers K.K.); and resin c is E1022 (trademark), an emulsifier-added aqueous emulsion type epoxy resin (a resin produced by Yoshimura Oil Chemical Co., Ltd., which is a thermosetting resin obtained by the addition of the hardener H-35 (trademark) provided by the same company).

The thus obtained treating liquids (whose pH values all fall in a range of 11 to 12) were each stored for 2 weeks at 40° C. to investigate their storage stability, and the results are also given in Table 1 (in Table 1, “fair” means that a favorable dispersion is obtained after 2 weeks from the preparation time, “poor” means that solid deposit of the components was found to generate within 4 days, and “very poor” means that solid deposit of the components was found to generate within 1 day).

TABLE 1

| | Aqueous solution of | | | | | |
|---|---|---|---|---|---|---|
| | alkali silicate used as the base | | | Resin added | | |
| | | Content of | | | Resin content in | Stability of |
| Treating | | alkali silicate | Na content | | treating liquid | treating |
| liquid No. | Type¹⁾ | (wt %) | (wt %) | Type²⁾ | (wt %) | liquid |
| 1 | A | 10 | 0.4 | a | 0.5 | fair |
| 2 | A | 10 | 0.4 | a | 1.0 | fair |
| 3 | B | 10 | 0.2 | a | 1.5 | fair |
| 4 | A | 10 | 0.4 | a | 2.0 | fair |
| 5 | C | 10 | 0 | a | 2.0 | fair |
| 6 | C | 5 | 0 | a | 5.0 | fair |
| 7 | A | 15 | 0.6 | a | 0.5 | fair |
| 8 | D | 10 | 0.9 | a | 1.0 | fair |
| 9 | A | 1 | 0.04 | a | 10.0 | fair |
| 10 | A | 10 | 0.4 | b | 1.0 | poor |
| 11 | A | 10 | 0.4 | b | 2.0 | poor |
| 12 | A | 10 | 0.4 | b | 5.0 | very poor |
| 13 | E | 10 | 1.9 | b | 1.0 | poor |
| 14 | A | 1 | 0.04 | c | 10.0 | poor |
| 15 | A | 10 | 0.4 | — | 0 | fair |

*¹⁾A: Lithium silicate (n = 4.5)/sodium silicate (n = 3) = 4/1 (weight ratio) B: Lithium silicate (n = 4.5)/sodium silicate (n = 3) = 9/1 (weight ratio) C: Lithium silicate (n = 4.5) D: Lithium silicate (n = 4.5)/sodium silicate (n = 3) = 5/4 (weight ratio) E: Sodium silicate (n = 3)
*²⁾a: F2000 b: M6520 c: E1022

As can be clearly understood from Table 1, the treating liquids (Nos. 1 to 9) containing the soap-free aqueous emulsion of resin dispersed in aqueous solution of alkali silicate all showed excellent storage stability, and exhibited excellent dispersibility after storing for two weeks from the preparation time of the treating liquids. On the other hand, the treating liquids (Nos. 10 to 14) containing the emulsifier-added aqueous emulsion of resin dispersed in aqueous solution of alkali silicate all showed inferior storage stability.

2: Formation of Corrosion-Resistant Film and the Properties Thereof

After removing the adhered magnetic powder from the surface of the bulk magnet test pieces by means of ultrasonic cleaning in acetone, the test pieces were immersed in each of the treating liquids 3 hours after preparation. Then, the bulk magnet test pieces were each drawn out of the treating liquids, and were heated and dried at 200° C. for 20 minutes to form the corrosion-resistant film on the surface of each test piece. The coverage of the film was adjusted by controlling the wiping pressure of air wiping.

The properties of the corrosion-resistant films thus formed are shown in Table 2. In Table 2, the heat-resistance and corrosion-resistance is evaluated by subjecting the bulk magnet test piece having the corrosion-resistant film on the surface thereof to 120 times of heating and cooling cycles, i.e., repeating 120 times the set of holding at room temperature (25° C.) for 1 hour and then holding at 170° C. for 1 hour in the atmosphere, then subjecting to humidity test comprising holding the resulting test piece under high temperature and high humidity condition of 80° C. and 90% relative humidity to measure the time elapsed until red rust generated on 1% of the surface of the bulk magnet test piece (an average of n=5). The change in magnetic flux is shown by taking the change ratio (demagnetization ratio) for before and after carrying out the 120 times of heating and cooling cycles and the subsequent humidity test (an average of n=5) on the bulk magnet test piece having the corrosion-resistant film on the surface thereof. The adhesiveness is shown by adhering a 20 mm by 20 mm size Cellotape (registered trademark of Nichiban Co., Ltd.) to 30 mm by 20 mm size surface of the corrosion-resistant film, measuring the strength on pulling off the Cellotape in the 180 degree horizontal direction, and expressing the adhesiveness by “(the strength immediately after forming the corrosion-resistant film)/(the strength after holding the corrosion-resistant film for 2 weeks in room)” (average of n=5).

TABLE 2

| | | Resin | | | | | |
|---|---|---|---|---|---|---|---|
| Treating | Coverage of | content in | Na content | Heat-resistance | Change in | | |
| liquid | film | film | in film | corrosion-resistance | magnetic | Adhesiveness | |
| No. | (g/m²) | (wt %) | (wt %) | (hours) | flux (%) | (g/400 mm²) | Evaluation |
| 1 | 0.8 | 4.8 | 3.6 | 192 | <1 | 380/350 | Example |
| 2 | 0.8 | 9.1 | 3.5 | 192 | <1 | 390/370 | Example |
| 3 | 0.8 | 13.0 | 1.8 | 216 | <1 | 380/370 | Example |
| 4 | 0.8 | 16.7 | 3.2 | 216 | <1 | 400/380 | Example |
| 5 | 0.8 | 16.7 | <0.1 | 216 | <1 | 380/380 | Example |
| 6 | 3.0 | 50.0 | 0 | 192 | <1 | 380/350 | Example |
| 7 | 1.5 | 3.2 | 4.0 | 216 | <1 | 380/350 | Example |
| 8 | 0.8 | 9.1 | 8.2 | 192 | <1 | 370/350 | Example |
| 9 | 0.8 | 90.0 | 0.3 | 96 | 2 | 350/300 | Comparative |
| 10 | 0.8 | 9.1 | 1.7 | 96 | 2 | 350/240 | Comparative |
| 11 | 0.8 | 16.7 | 1.6 | 96 | 2 | 330/250 | Comparative |
| 12 | 0.8 | 33.3 | 1.3 | 72 | 2 | 300/200 | Comparative |
| 13 | 0.8 | 9.1 | 17.3 | 96 | 2 | 330/150 | Comparative |
| 14 | 0.8 | 90.0 | 0.3 | 144 | 2 | 330/320 | Comparative |
| 15 | 0.8 | 0 | 3.8 | 144 | <1 | 370/300 | Comparative |

It is clearly understood from Table 2 that the films formed from the treating liquid prepared by dispersing a thermoplastic resin in the form of a soap-free aqueous emulsion of resin in aqueous solution of alkali silicate and containing the thermoplastic resin uniformly dispersed in the film at a content of 50 wt % or less show excellent corrosion-resistance.

### Example B

According to disclosures of, for example, U.S. Pat. No. 4,770,723 or U.S. Pat. No. 4,792,368, a known cast ingot was pulverized and then subjected sequentially to a pressing, a sintering, a heat treatment and a surface working, thereby producing a cylindrical sintered magnet having the size of 9 mm in diameter and 3 mm in height, with the composition of 14Nd-79Fe-6B-1Co (at %) (which is referred to hereinafter as bulk magnet test piece). A corrosion-resistant film was formed on the surface of the thus obtained bulk magnet test piece using the treating liquid 4 employed in Example A in the same manner as that described in Example A.

The adhesiveness of the thus formed corrosion-resistant film with various types of adhesives was evaluated immediately after forming the film and after subjecting it to humidity test by allowing to stand for 100 hours under high temperature and high humidity condition of 80° C. and 90% relative humidity.

Adhesive 1:

The sample was adhered to the adhesion plane of a cast iron (S45C) jig having the size of 40 mm by 50 mm by 60 mm that was subjected to polishing using diamond grinding stone having #100 abrasives according to JIS R6001 standard in the following manner. More specifically, a primer (Primer 7649: trademark of Henkel Japan K.K.) was applied to both adhesion planes of the sample and the jig. After drying for removal of the solvent in the primer, the sample having an anaerobic ultraviolet-curable adhesive (Loctite366: trademark of Henkel Japan K.K.) applied to the adhesion plane was mounted on the adhesion plane of the jig, and they were both pressure adhered by applying a load of 4 kgf (39.2 N) on the sample for 10 seconds. In this case, the adhesive was applied to the sample adhesion plane in such a manner that the adhesive should leak out from the periphery of the pressure adhered portion during the pressure adhesion. The adhesive squeezed out from the periphery of the pressure adhered portion was cured by irradiating 365 nm ultraviolet radiation at an intensity of 100 mW/cm² for 2 minutes using an ultraviolet irradiator (HLR100T-1: product of SEN LIGHTS CORPORATION), and the adhesive of the pressure adhered portion was cured by allowing the sample to stand at room temperature (25° C.) for 60 hours. The sample adhered to the jig in the manner described above was set on a universal testing machine (AUTO GRAPH AG-10TB: product of Shimadzu Corporation), and by applying a shear strength of 2 mm/min, the load at the instance the sample was detached from the jig was measured, which was divided by the surface area of the sample adhesion plane (0.64 cm²) to obtain the shear adhesion strength. The average value (n=5) was employed as the evaluation standard of adhesiveness.

Adhesive 2:

The adhesiveness was evaluated in the same manner as in the case of adhesive 1, except for using a modified acrylate-based adhesive (HARDLOC G55: trademark of DENKI KAGAKU KOGYO KABUSHIKI KAISHA) as the adhesive. In this case using adhesive 2, the sample was adhered to the jig by mounting the sample applied with the adhesive on the adhesion plane of the jig, pressure adhering by applying a load of 4 kgf (39.2 N) on the sample for 10 seconds, and by allowing the sample to stand at room temperature (25° C.) for 60 hours to cure the adhesive in the pressure adhered portion.

Adhesive 3:

The adhesiveness was evaluated in the same manner as in the case of adhesive 1, except for using adhesive 3 obtained by mixing a thermosetting epoxy-based adhesive (AV138: trademark of Ciba-Geigy Corp.) and a hardener (HV998: trademark of Ciba-Geigy Corp.) at a volume ratio of 5:1. In this case using adhesive 3, the sample was adhered to the jig by mounting the sample applied with the adhesive on the adhesion plane of the jig, pressure adhering by applying a load of 4 kgf (39.2 N) on the sample for 10 seconds, and by heating the sample and the jig to 100° C. for 30 minutes to cure the adhesive in the pressure adhered portion.

It is clearly understood from Table 3 that the corrosion-resistant film formed according to the invention maintains excellent adhesiveness free from deterioration of the film even in case it is exposed to severe conditions for a long term.

TABLE 3

| | Adhesive 1 | Adhesive 2 | Adhesive 3 |
|---|---|---|---|
| On forming film | 215 | 220 | 380 |
| After humidity test | 210 | 210 | 380*⁾ |

Unit: kg/cm²
n = 5
*⁾Break due to of adhesive coagulation occurred partly

### INDUSTRIAL APPLICABILITY

The invention provides a rare earth metal-based permanent magnet which has on the surface an inexpensive corrosion-resistant film combining excellent heat-resistance with excellent adhesiveness; a process for producing the permanent magnet; and a treating liquid for forming the corrosion-resistant film.

1. A rare earth metal-based permanent magnet characterized by that it has on the surface a corrosion-resistant film containing lithium silicate and a thermoplastic resin as the constituting components, said film containing uniformly dispersed therein the thermoplastic resin at a content of 0.1 wt % to 50 wt %.

2. The rare earth metal-based permanent magnet as claimed in claim 1, characterized by that the film further contains sodium silicate as the constituting component.

3. The rare earth metal-based permanent magnet as claimed in claim 2, characterized by that the film has sodium content of 10 wt % or less.

4. The rare earth metal-based permanent magnet as claimed in claim 1, characterized by that the thermoplastic resin is a soap-free aqueous emulsion of resin.

5. The rare earth metal-based permanent magnet as claimed in claim 1, characterized by that the thermoplastic resin is acrylic-styrene resin.

6. The rare earth metal-based permanent magnet as claimed in claim 1, characterized by that the magnet has the film at a surface coverage of 0.01 g/m² to 5.0 g/m² of the magnet.

7. A process for producing a rare earth metal-based permanent magnet characterized by that it comprises preparing a treating liquid containing from 0.1 wt % to 5 wt % of a thermoplastic resin and from 2 wt % to 30 wt % of lithium silicate by dispersing the thermoplastic resin in the form of a soap-free aqueous emulsion of resin in an aqueous solution of lithium silicate, and after applying the treating liquid to the surface of the magnet, heating and drying it to obtain the corrosion-resistant film.

8. The production process as claimed in claim 7, characterized by that the treating liquid further contains sodium silicate.

9. The production process as claimed in claim 8, characterized by that the sodium content of the treating liquid is 1 wt % or less.

10. The production process as claimed in claim 7, characterized by that the thermoplastic resin is acrylic-styrene resin.

11. A treating liquid for forming a corrosion-resistant film on the surface of a rare earth metal-based permanent magnet, characterized by that it contains from 0.1 wt % to 5 wt % of a thermoplastic resin in the form of a soap-free aqueous emulsion of resin and from 2 wt % to 30 wt % of lithium silicate.

12. The treating liquid as claimed in claim 11, characterized by that the treating liquid further contains sodium silicate.

13. The treating liquid as claimed in claim 12, characterized by that the sodium content of the treating liquid is 1 wt % or less.

14. The treating liquid as claimed in claim 11, characterized by that the thermoplastic resin is acrylic-styrene resin.
